(19) United States
(12) Patent Application Publication
(10) Pub. No.: US 2017/0312900 A1
(43) Pub. Date: Nov. 2, 2017

(54) BUTTON HEAD SCREW REMOVAL TOOL AND METHOD

(71) Applicant: WILLIAM C. ROWE, APPLETON, WI (US)

(72) Inventor: WILLIAM C. ROWE, APPLETON, WI (US)

(21) Appl. No.: 15/584,311

(22) Filed: May 2, 2017

Related U.S. Application Data
(60) Provisional application No. 62/330,621, filed on May 2, 2016.

(51) Int. Cl. B25B 27/18; B25B 13/48

(52) U.S. Cl. CPC B25B 27/18; B25B 13/481

(57) ABSTRACT

A fastener removal tool system including a socket assembly. The socket assembly includes a cylindrical-body, with the cylindrical-body including an outer-cylindrical surface, an inner-cylindrical surface, a top-side, and a bottom-opening. The top-side preferably includes an opening to receive a torque providing tool. The inner-cylindrical surface includes a plurality of helical grooves nearest the bottom-opening to grip and removably affix to a head of a fastener to remove the fastener from a material when a torque is applied to the socket assembly by the torque providing tool.

### CROSS-REFERENCE TO RELATED APPLICATION

The present application is related to and claims priority to U.S. Provisional Patent Application No. 62/330,621 filed May 2, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of tools of existing art and more specifically relates to stud-removal and emplacement.

### 2. Description of Related Art

Mechanics or other tradespersons may often spend a great deal of time attempting to remove screws or other fasteners with heads or surfaces that are stripped or worn such that the fasteners cannot easily be removed with a conventional tool. In order to remove the damaged fastener, the tradesperson may often need to drill the damaged fastener head, and then attempt to remove with some type of extractor. In other instances, the material into which the fastener is located may need to be drilled itself to remove the damaged fastener.

The drilling of the fastener may develop much foreign object debris, which can contribute to an unsafe working environment or cause damage to the surrounding device. The drilling and extraction process is often time consuming to set up and can be labor intensive to employ. In addition, if the damaged fastener is in hard to reach areas, the fastener can be difficult to drill head on, which often results in further damage to the screw and the surrounding area. A suitable solution is desired.

U.S. Pat. No. 4,947,712 to Robert C. Brosnan relates to a socket device. The described socket device includes a wrench-type socket for removing bolts and the like whose head has become damaged or otherwise worn, thus prohibiting its removal by the use of a conventional socket. The disclosed socket includes an internal central cavity which is formed with at least one, but preferably a plurality, of elongated projections or shoulders which extend into the cavity, and which upon rotating the socket are intended to partially penetrate into the damaged bolt head and thus provide a driving connection therebetween to thereby provide torque to the bolt to thus cause its removal.

### BRIEF SUMMARY OF THE INVENTION

In view of the foregoing disadvantages inherent in the known tools art, the present disclosure provides a novel fastener removal tool system and method. The general purpose of the present disclosure, which will be described subsequently in greater detail, is to provide a tool to remove a damaged fastener that which would be otherwise unremovable by the intended hand tool related to the fastener.

A fastener removal tool system is disclosed herein. The fastener removal tool system includes a socket assembly. The socket assembly preferably includes a cylindrical-body, with the cylindrical-body including an outer-cylindrical surface, an inner-cylindrical surface, a top-side, and a bottom-opening.

The top-side preferably includes an opening to receive a torque providing tool (e.g., wrench, screwdriver, etc.). Also, the inner-cylindrical surface includes a plurality of helical grooves nearest the bottom-opening to grip and removably affix to a head of a fastener to remove the fastener from a material when a torque is applied to the socket assembly by the torque providing tool.

The helical grooves are arranged in a counter-clockwise rotation to remove the fastener and the opening of the top-side is configured to accept a male adaptor of the torque providing tool. Preferably, the torque providing tool is a socket wrench and the inner-cylindrical surface is configured to accept and therefore remove a button head screw. The fastener tool removal system preferably includes construction from a chromium molybdenum (a.k.a. chrome-moly) material to increase the strength, durability, and longevity of use for the system.

According to another embodiment, a method of using a fastener removal tool system is also disclosed herein. The method of using a fastener removal tool system includes a first step, locating a fastener to be removed; a second step, providing a fastener removal tool system; a third step, affixing the fastener removal tool system to the fastener to be removed; a fourth step, rotating the fastener removal tool system upon a head of the fastener to provide a torque upon the fastener; a fifth step, removing the fastener via the fastener removal tool system; and a sixth step, replacing said fastener with a second-fastener.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fastener removal tool system and method, constructed and operative according to the teachings of the present disclosure.

FIG. 1 is a perspective view of the fastener removal tool system during an ‘in-use’ condition, according to an embodiment of the disclosure.

FIG. 2 is a bottom-perspective view of the fastener removal tool system of FIG. 1, according to an embodiment of the present disclosure.

FIG. 3 is a side-perspective view of the fastener removal tool system of FIG. 1, according to an embodiment of the present disclosure.

FIG. 4 is a side cut-away view of the fastener removal tool system of FIG. 1, according to an embodiment of the present disclosure.

FIG. 5 is a flow diagram illustrating a method of using the fastener tool removal system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a stud-removal and emplacement and more particularly to a fastener removal tool system and method as used to improve the removal of a fastener that has become broken and/or worn such that the fastener is unremovable by a the originally intended removal tool.

Generally, fasteners may be stripped such that the fasteners cannot be removed with a standard screwdriver or other similar hand tool. When this occurs, the fastener's head usually must be drilled to a specific size to match a tapered counter-clockwise threaded screw extractor size, which may cause further problems. Drilling may create foreign object damage; it may takes a lot time to set up a safe working environment to start drilling in critical areas. Screw extractor tools put side pressure on the inside of the screw, and can add side pressure to a nut-plate it is screwed in to, which may cause slippage or additional damage.

If the fasteners are in hard to reach areas (which many are) one might not be able to drill straight on the fastener head which can creates other issues such as damaging the material the screw is holding together. Now after all this work was done, a nut-plate may have to be replaced as well. After all considered, much time, money, and resources have been expended. The present invention serves to provide a solution for the abovementioned problems.

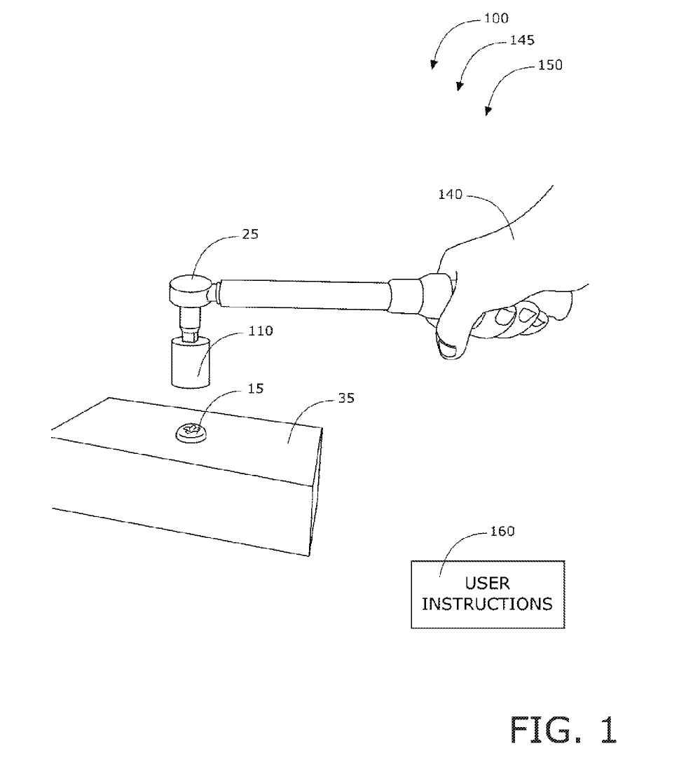

Referring now more specifically to the drawings by numerals of reference, there is shown in FIGS. 1-4, various views of a fastener removal tool system 100. FIG. 1 shows a fastener removal tool system 100 during an ‘in-use’ condition 150, according to an embodiment of the present disclosure. Here, the fastener removal tool system 100 may be beneficial for use by a user 140 to allow user 140 to remove a damaged or worn fastener 15 without a need to drill or cause damage to the surrounding material 35 into which fastener 15 is affixed. As illustrated, the fastener removal tool system 100 may include socket assembly 110, with socket assembly 110 including cylindrical-body 112.

According to one embodiment, the fastener removal tool system 100 may be arranged as a kit 105. In particular, the fastener removal tool system 100 may further include a set of instructions 155. The instructions 155 may detail functional relationships in relation to the structure of the fastener removal tool system 100 (such that the fastener removal tool system 100 can be used, maintained, or the like, in a preferred manner).

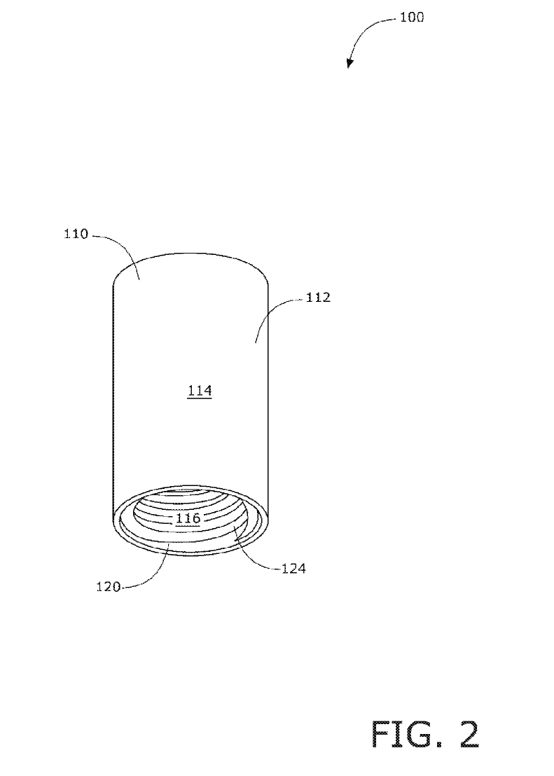

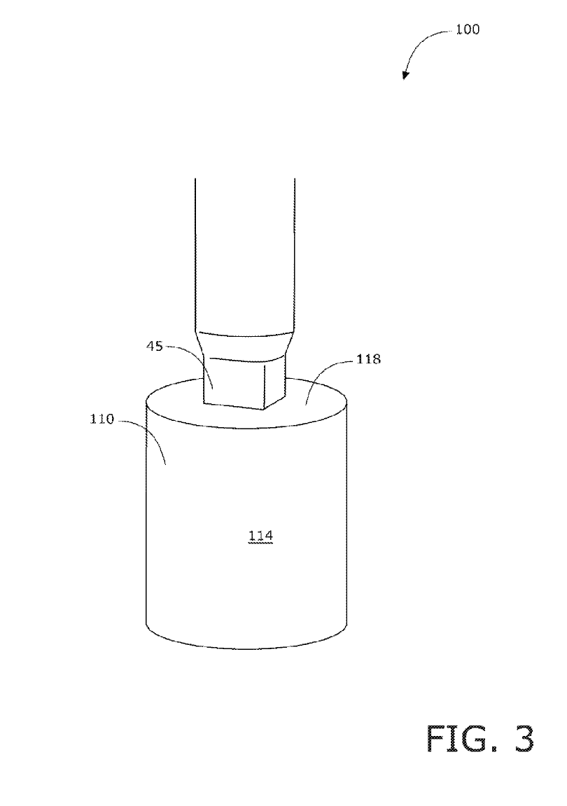

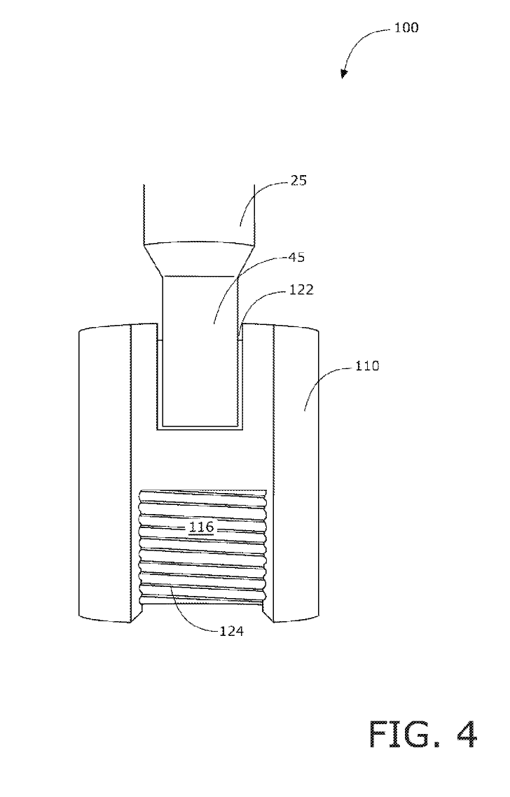

As shown in FIG. 2, socket assembly 110 of fastener removal tool system 100 may include cylindrical-body 112. Cylindrical-body 112 may include outer-cylindrical 114 surface, inner-cylindrical surface 116, top-side 118, and bottom-opening 120. As shown in FIG. 2 (and also FIG. 4), inner-cylindrical surface 116 may include a plurality of helical grooves 124 nearest bottom-opening 120 to grip and removably affix to a head of fastener 15 to remove fastener 15 from a material 35 when a torque is applied to socket assembly 110 via torque providing tool 25. As shown in FIG. 3, top-side 118 may include opening 122 to receive torque providing tool 25.

In some embodiments, helical grooves 124 may be arranged in a clockwise rotation to remove fastener 15. Other embodiments may include helical grooves 124 arranged in a counter-clockwise rotation to remove fastener 15. Opening of top-side 118 may be configured to accept different types of torque providing tool(s) 25. As such, opening 122 of top-side 118 may be configured to accept male adaptor of torque providing tool 45, or a female adaptor of torque providing tool 25. Torque providing tool 25 may include a socket wrench, a screw-driver, an impact-wrench, or a torque-wrench, in some embodiments. Additional embodiments may include additional torque providing tools 25.

Fastener removal tool system 100 may be configured to accommodate specific types and/or sizes of fastener(s) 15, in embodiments disclosed. As such, inner-cylindrical surface 116 may be configured to accept and remove a 10/32-inch button head screw or inner-cylindrical surface 116 may be configured to accept and remove an 8/32-inch button head screw. Embodiments may also include other fastener-types and/or sizes. For example, inner-cylindrical surface 116 may removably affix to a hex-head fastener 15; inner-cylindrical surface 116 may removably affixes to a square-head fastener 15, button-head screw fastener 15, or other fastener 15 depending upon embodiments.

Fastener removal tool system 100 may be constructed from a wide variety of materials, depending upon user preferences and specific applications. As such, fastener removal tool system 100 may constructed from a chrome-moly material for increased strength and durability during use, fastener removal tool system 100 may be constructed from an aluminized material to decrease weight during use, or constructed from a ferrous-metallic material for increased durability during use. Additional materials may also be used.

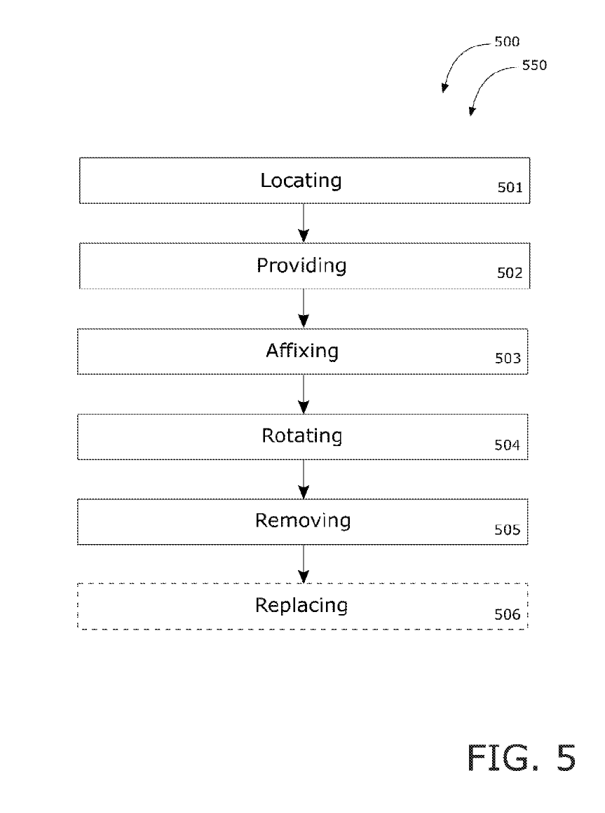

FIG. 5 is a flow diagram 550 illustrating a method of use 500 for a fastener removal tool system 100, according to an embodiment of the present disclosure. In particular, the method of using 500 a fastener removal tool system 100 may include one or more components or features of the fastener removal tool system 100 as described above. As illustrated, the method of using a fastener removal tool system 500 may include the steps of: step one 501, locating fastener 15 to be removed; step two 502, providing fastener removal tool system 100; step three 503, affixing fastener removal tool system 100 to fastener 15 to be removed; step four 504, rotating fastener removal tool system 100 upon a head of fastener 15 to provide a torque upon fastener 15; step five 505, removing fastener 15 via fastener removal tool system 100; and step six 506, replacing fastener 15 with a second-fastener.

It should be noted that step six 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for method of using a fastener removal tool system (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fastener removal tool system, said system comprising:
a socket assembly, said socket assembly comprising a cylindrical-body, said cylindrical-body comprising an outer-cylindrical surface, an inner-cylindrical surface, a top-side, and a bottom-opening;
wherein said top-side includes an opening to receive a torque providing tool; and
wherein said inner-cylindrical surface includes a plurality of helical grooves nearest said bottom-opening to grip and removably affix to a head of a fastener to remove said fastener from a material when a torque is applied to said socket assembly via said torque providing tool.

2. The fastener removal tool system of claim 1, wherein said helical grooves are arranged in a clockwise rotation to remove said fastener.

3. The fastener removal tool system of claim 1, wherein said helical grooves are arranged in a counter-clockwise rotation to remove said fastener.

4. The fastener removal tool system of claim 1, wherein said opening of said top-side is configured to accept a male adaptor of said torque providing tool.

5. The fastener removal tool system of claim 1, wherein said opening of said top-side is configured to accept a female adaptor of said torque providing tool.

6. The fastener removal tool system of claim 1, wherein said torque providing tool is a socket wrench.

7. The fastener removal tool system of claim 1, wherein said torque providing tool is a screw-driver.

8. The fastener removal tool system of claim 1, wherein said torque providing tool is an impact-wrench.

9. The fastener removal tool system of claim 1, wherein said torque providing tool is a torque-wrench.

10. The fastener removal tool system of claim 1, wherein said inner-cylindrical surface is configured to accept and remove a 10/32-inch button head screw.

11. The fastener removal tool system of claim 1, wherein said inner-cylindrical surface is configured to accept and remove a 8/32-inch button head screw.

12. The fastener removal tool system of claim 1, wherein said inner-cylindrical surface removably affixes to a hex-head fastener.

13. The fastener removal tool system of claim 1, wherein said inner-cylindrical surface removably affixes to a square-head fastener.

14. The fastener removal tool system of claim 1, wherein said system is constructed from a chrome-moly material for increased strength and durability during use.

15. The fastener removal tool system of claim 1, wherein said system is constructed from an aluminized material to decrease weight during use.

16. The fastener removal tool system of claim 1, wherein said system is constructed from a ferrous-metallic material for increased durability during use.

17. A fastener removal tool system, said system comprising:
a socket assembly, said socket assembly comprising a cylindrical-body, said cylindrical-body comprising an outer-cylindrical surface, an inner-cylindrical surface, a top-side, and a bottom-opening;
wherein said top-side includes an opening to receive a torque providing tool;
wherein said inner-cylindrical surface includes a plurality of helical grooves nearest said bottom-opening to grip and removably affix to a head of a fastener to remove said fastener from a material when a torque is applied to said socket assembly via said torque providing tool.
wherein said helical grooves are arranged in a clockwise rotation to remove said fastener;
wherein said opening of said top-side is configured to accept a male adaptor of said torque providing tool;
wherein said torque providing tool is a socket wrench;
wherein said inner-cylindrical surface is configured to accept and remove a button head screw; and
wherein said system is constructed from a chrome-moly material for increased strength and durability during use.

18. The fastener removal tool system of claim 17, further comprising set of instructions; and wherein said system is arranged as a kit.

19. A method of using a fastener removal tool system, the method comprising the steps of:
locating a fastener to be removed;
providing a fastener removal tool system;
affixing said fastener removal tool system to said fastener to be removed;
rotating said fastener removal tool system upon a head of said fastener to provide a torque upon said fastener; and
removing said fastener via said fastener removal tool system.

20. The method of claim 19, further comprising the step of:
replacing said fastener with a second-fastener.
